(19) United States
(12) Patent Application Publication
(10) Pub. No.: US 2006/0269753 A1
(43) Pub. Date: Nov. 30, 2006

(54) Creamic substrate and production method thereof

(75) Inventors: Chun-Wei Peng, Taoyuan Hsien (TW); Ming-Shan Shiu, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/437,613

(22) Filed: May 22, 2006

(30) Foreign Application Priority Data
May 26, 2005 (CN) 200510072079X

(51) Int. Cl. B32B 9/00; B32B 19/00

(52) U.S. Cl. 428/408; 428/688

(57) ABSTRACT

A production method of a ceramic substrate includes the steps of: providing a graphite substrate and at least one ceramic structure; laminating the ceramic structure and the graphite substrate; and sintering the ceramic structure and the graphite substrate. Moreover, a ceramic substrate, which includes at least one ceramic structure and a graphite substrate, is provided. The ceramic structure and the graphite substrate are laminated. After laminating, the ceramic structure and the graphite substrate are sintered to form a ceramic substrate.

### BACKGROUND OF THE INVENTION

1. Field of Invention

The invention relates to a ceramic substrate and production method thereof. In particular, the invention relates to a ceramic substrate with a graphite substrate and production method thereof.

2. Related Art

Accompanying with the progress of technology, the trend in modem electronics is to make devices compact and light. Take the personal mobile communication products in the wireless communication industry as an example. The dimensions of these personal mobile communication products have evolved within a couple of years from the hand-held size down to smaller than a palm and can be put into a watch. The functions are increased from the simplest voice transmission to others including the transmissions of data, graphics, and text along with many versatile utilities. Consequently, the low-temperature sinter ceramics (LTCC) is particularly suitable for such needs. The LTCC technique is a technique for implementing the integration of high-frequency circuits. It uses the method of embedding low-resist metal layers in multiple ceramic layers to embed the passive elements in a two-dimensional planar high-frequency circuit into three-dimensional ceramic layers. The surface area can be reduced by increasing the spatial usage rate and achieving integration of a compact circuit.

The LTCC technique has many advantages. It can perform the sinter process at a low temperature (1000° C.). The ceramic layers can be sintered with metals of low resistance and low dielectric loss. The number of the layers is not limited. Passive elements such as inductors and capacitors can be readily embedded therein. Therefore, the LTCC technique is very suitable for integrating devices.

With reference to FIG. 1 showing a cross-sectional view of the conventional ceramic substrate, the conventional ceramic substrate 1 mainly comprises a plurality of ceramic layers 11. Its production procedure is as follows. First, green tapes are formed to produce several ceramic layers 11. Each ceramic layer 11 is processed with via hole punching, via filling, and pattern printing on a metal conductor 111. Then, passive elements are formed on the ceramic layers 11 by halftone printing for subsequent processes of forming surfaces or embedded passive elements 112 by laminating and sintering. Afterwards, the ceramic layers 11 are stacked and pre-laminated, so that they are compactly stacked, followed by low-temperature sintering to produce the ceramic substrate 1.

However, during the low-temperature sintering process, the ceramic layer 11 will contract, particularly in the planar direction. This causes the problem of deformation of the circuits on the ceramic layers 11 or the whole ceramic substrate 1. Accordingly, the manufacturing cost and the difficulties in circuit design and production may increase, and the size of the ceramic substrate 1 must be limited.

In the production of LTCC substrates, it is well-known to impose an external force during the sintering process to restrict the planar contraction rate of the ceramic substrate, as in U.S. Pat. No. 5,130,067. Alternatively, a layer of aluminum oxide is added to the top and bottom of the ceramic layers to provide a frictional force in the sintering process. This can limit the contraction rate of the ceramic layers. The aluminum oxide is removed after the sintering process is done. However, the above-mentioned methods complicate the production process and thus are not suitable for mass production. With regarding to the sintering temperature, the contraction properties, and electrical properties at the same time, it is an important subject of the invention to provide a ceramic substrate with less contraction and having simplified production processes and reduced manufacturing cost.

### SUMMARY OF THE INVENTION

In view of the foregoing, the invention is to provide a ceramic substrate with less contraction and the production method thereof.

To achieve the above, a method for manufacturing a ceramic substrate of the invention includes the steps of: providing a ceramic structure; providing a graphite substrate; laminating the ceramic structure and the graphite substrate; and sintering the laminated ceramic structure and graphite substrate.

In addition, a ceramic substrate of the invention includes at least a ceramic structure and a graphite substrate. In the invention, the ceramic structure and the graphite substrate are laminated and sintered to form a ceramic substrate.

As mentioned above, the method for manufacturing a ceramic substrate of the invention is to sinter the ceramic structure and the graphite substrate at a low temperature. Since the graphite substrate can provide a planar friction to the ceramic structure, the planar contraction rate of the ceramic structure is thus reduced. Besides, the graphite substrate can be used to increase the thermal conductivity of the ceramic substrate. Accordingly, the industrial requirements can be satisfied and the contraction rate of the ceramic substrate can be reduced.

### BRIEF DESCRIPTION OF THE DRAWINGS

The invention will become more fully understood from the detailed description given herein below illustration only, and thus is not limitative of the present invention, and wherein:

FIG. 1 is a cross-sectional view of the conventional ceramic substrate;

FIG. 2 is a cross-sectional view of a ceramic substrate according to a preferred embodiment of the invention; and

FIG. 3 is a flowchart of a method for manufacturing a ceramic substrate according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

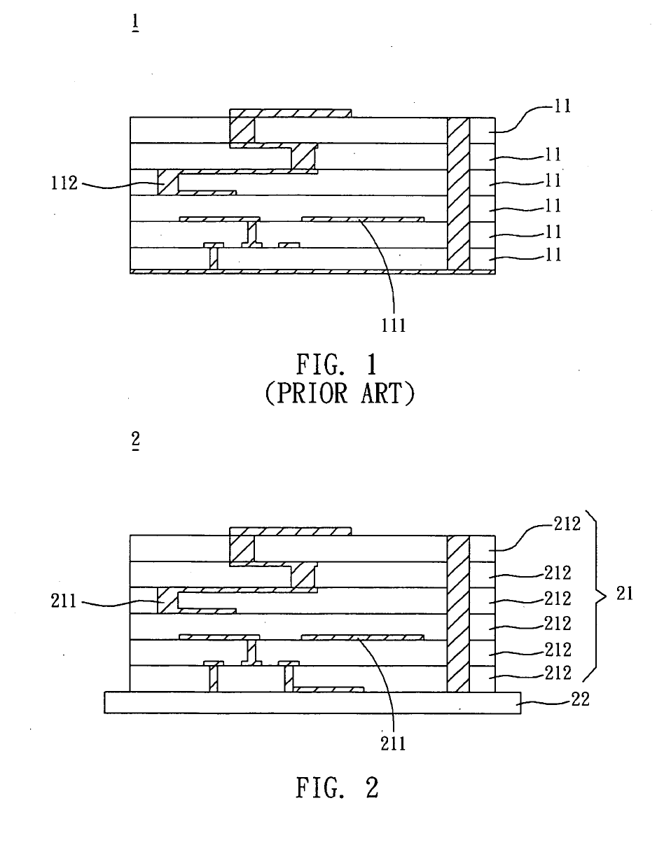

As shown in FIG. 2 showing a cross-sectional view of a ceramic substrate 2 according to a preferred embodiment of the invention, the ceramic substrate 2 comprises at least a ceramic structure 21 and a graphite substrate 22.

The ceramic structure 21 is made of a mixture of ceramic powders and glass powders in different ratios, adjusted according to the required coefficient of thermal expansion (CTE) or other manufacturing parameters. Generally speaking, the ingredients of the ceramic structure 21 comprise aluminum oxide, quartz, CaZrO3, Mg3SiO4, silica, andalusite, silicon dioxide, borosilicate glass, or any other suitable raw material for the ceramic.

Besides, at least one device 211 is formed in/on the ceramic structure 21. The device 211 may be a passive device such as a capacitor, a resistor, or an inductor, an active device, or a wire. The method of forming the device 211 may be via hole punching/via filling, printing, lithography, physical vapor deposition (PVD) or chemical vapor deposition (CVD). The material of the device 211 is gold, silver, copper or other conductive materials. Moreover, the ceramic structure 21 may be composed of a single ceramic layer 212 or multiple ceramic layers 212 laminated together.

The graphite substrate 22 is positioned under the ceramic structure 21. The surface of the graphite substrate 22 is cleansed in advance to avoid impurities thereon. Besides, the surface of the graphite substrate 22 may be formed with a circuit, a device, or an adhesive layer. When the surface of the graphite substrate 22 is formed with an adhesive layer, it can enhance the connection between the graphite substrate 22 and the ceramic structure 21. The adhesive layer can also be formed on the surface of the ceramic structure 21. The graphite substrate in this embodiment uses graphite foam with the following properties for the illustration purposes, but not limited to this example.

Density: 0.9 g/cm3;

Compressive strength: 855 psi;

Thermal conductivity: 70 W/m-° C.; and

CTE: 3.26 ppm/k at the temperature of 600-800° C.

Besides, after the ceramic structure 21 and the graphite substrate 22 are sintered at the low temperature to form the ceramic substrate 2, the surface of the ceramic substrate 2 can be further printed with a circuit according to needs. Moreover, an additional sinter process can be performed on the surface of the ceramic substrate 2.

As described above, it is seen that the expansion coefficient of the graphite substrate 22 in the planar direction is less than 5 ppm/k during the low temperature sinter process (here the low-temperature sinter temperature is lower than 950° C.). Therefore, when the ceramic substrate 2 is sintered at low temperature, the graphite substrate 22 can provide a planar friction to the ceramic structure 21 for reducing the contraction thereof. Besides, the thermal conductivity of the graphite substrate 22 is better than the ceramic structure 21. Thus, the overall thermal conductivity of the ceramic substrate 2 is improved. Since the graphite substrate 22 is conductive, it can be considered as a ground layer for RF shielding without worrying about removing it.

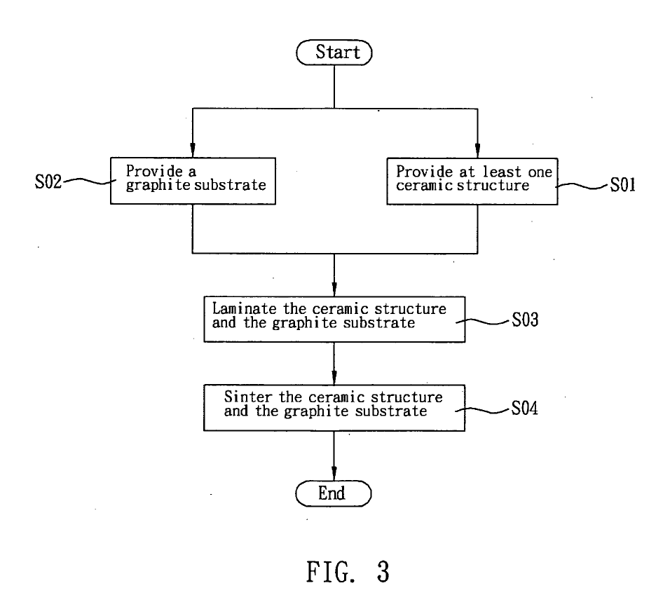

With reference to FIG. 3, an embodiment of the method for manufacturing a ceramic substrate includes the following steps.

In step S01, at least one ceramic structure 21 is provided. The device 211 (e.g. a resistor, an inductor, or a capacitor, etc) can be formed on the ceramic structure 21 by via hole punching, via filling or pattern printing. In this step, the ceramic structure 21 may be formed by laminating several ceramic layers 212.

In step S02, a graphite substrate 22 is provided. The provided graphite substrate 22 may be surface cleaned or be formed with some devices thereon in advance.

In step S03, the ceramic structure 21 and the graphite substrate 22 are laminated. In the case, a high pressure can be applied to bonding the ceramic structure 21 and the graphite substrate 22.

In step S04, the ceramic structure 21 and the graphite substrate 22 are sintered. During the sinter process, the graphite substrate 22 provides a planar friction for the ceramic structure 21 so as to reduce the planar contraction thereof and render a ceramic substrate 2 with a smaller contraction.

To meet certain circuit requirements, the sintered ceramic substrate 2 may further undergo a surface conductor printing process and a low-temperature sinter process.

In summary, the method for manufacturing a ceramic substrate of the invention is to sinter the ceramic structure and the graphite substrate at a low temperature. Since the graphite substrate can provide a planar friction to the ceramic structure, the planar contraction rate of the ceramic structure is thus reduced. Moreover, the graphite substrate is conductive and therefore can be considered as a ground layer for RF shielding without worrying about removing it. In comparison with the conventional low-temperature ceramic sinter technique, the ceramic substrate and its production method of the invention can achieve the effect of reducing the planar contraction rate of the ceramic substrate without involving too many complicated processes. Besides, the graphite substrate can be used to increase the thermal conductivity of the ceramic substrate. Accordingly, the industrial requirements can be satisfied and the contraction rate of the ceramic substrate can be reduced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method for manufacturing a ceramic substrate, comprising the steps of:
providing at least one graphite substrate and at least one ceramic structure;
laminating the ceramic structure and the graphite substrate; and
sintering the ceramic structure and the graphite substrate.

2. The method of claim 1, wherein the step of providing the graphite substrate comprises a step of:
cleaning the graphite substrate.

3. The method of claim 1, further comprising a step of:
forming a device on the graphite substrate or in/on the ceramic stature.

4. The method of claim 3, wherein the device is a wire, a resistor, a capacitor, or an inductor.

5. The method of claim 3, wherein the device is formed by via hole punching, via filling, pattern printing, lithography, physical vapor deposition (PVD), or chemical vapor deposition (CVD).

6. The method of claim 3, wherein the device is made of gold, copper or an electrically conductive material.

7. The method of claim 1, further comprising a step of:
forming an adhesive layer on the graphite substrate or the ceramic structure.

8. The method of claim 1, wherein the graphite substrate is made of graphite foam.

9. The method of claim 1, further comprising a step of:
punching via holes on the ceramic structure and filling the via holes.

10. The method of claim 1, wherein the ceramic structure is composed of a plurality of ceramic layers.

11. The method of claim 1, further comprising an additional sintering step after printing a wire or a circuit on the ceramic structure or the graphite substrate.

12. The method of claim 1, further comprising a step of:
printing a wire or a circuit on a surface of the ceramic structure or the graphite substrate after sintering the ceramic structure and the graphite substrate.

13. The method of claim 1, wherein a temperature for sintering the ceramic structure or the graphite substrate is lower than 950° C.

14. The method of claim 1, wherein the material of the ceramic substrate is aluminum oxide, quartz, CaZrO3, Mg3SiO4, silica, andalusite, silicon dioxide, borosilicate glass, or glass ceramic.

15. A ceramic substrate, comprising:
at least one ceramic structure; and
a graphite substrate, which is sintered with the ceramic structure to form the ceramic substrate.

16. The ceramic substrate of claim 15, further comprising:
at least one device disposed on the graphite substrate or in/on, the ceramic structure.

17. The ceramic substrate of claim 16, wherein the device is a wire, a resistor, a capacitor, or an inductor.

18. The ceramic substrate of claim 15, further comprising:
an adhesive layer formed on the graphite substrate or the ceramic structure.

19. The ceramic substrate of claim 15, further comprising:
a wire disposed on a surface of the sintered ceramic substrate.

20. The ceramic substrate of claim 15, wherein the graphite substrate is a ground layer for RF shielding.
